(19) United States
(12) Patent Application Publication
(10) Pub. No.: US 2026/0011816 A1
(43) Pub. Date: Jan. 8, 2026

(54) TEMPERATURE CONTROL PLATE AND A BATTERY STORAGE ARRANGEMENT WITH SUCH A TEMPERATURE CONTROL PLATE

(71) Applicant: Benteler Automobiltechnik GmbH, Paderborn (DE)

(72) Inventors: Elmar Grussmann, Altenbeken (DE); Lars Landermann, Herford (DE)

(73) Assignee: Benteler Automobiltechnik GmbH, Paderborn (DE)

(21) Appl. No.: 19/258,501

(22) Filed: Jul. 2, 2025

(30) Foreign Application Priority Data
Jul. 3, 2024 (EP) 24186313.3

(51) Int. Cl. H01M 10/6557; H01M 10/617; H01M 10/647; H01M 10/6555; H01M 10/6568; H01M 50/209

(52) U.S. Cl. CPC H01M 10/6557; H01M 10/617; H01M 10/647; H01M 10/6555; H01M 10/6568; H01M 50/209

(57) ABSTRACT

A temperature control plate includes an upper and a lower cover plate, and a support plate connected to the upper and lower cover plates. The support plate includes a temperature control channel profiling forming upper and lower temperature control channels between the support plate and the upper and lower cover plates, with the upper temperature control channels running between the upper cover plate and the support plate and with the lower temperature control channels running between the lower cover plate and the support plate. The support plate includes through openings to connect the upper and lower temperature control channels with one another such as to realize a deflection of a temperature control medium. The through openings exhibit different diameters depending on a length of a path of the temperature control medium from a temperature control medium port to the through openings, with the diameter increasing as the path becomes longer.

### CROSS-REFERENCES TO RELATED APPLICATIONS

This application claims the priority of European Patent Application, Serial No. 24186313.3, filed Jul. 3, 2024, pursuant to 35 U.S.C. 119 (a)-(d), the disclosure of which is/are incorporated herein by reference in its entirety as if fully set forth herein.

### BACKGROUND OF THE INVENTION

The invention relates to a temperature control plate and to a battery storage arrangement.

The following discussion of related art is provided to assist the reader in understanding the advantages of the invention, and is not to be construed as an admission that this related art is prior art to this invention.

Performance and service life of a battery depends on the operating temperature. To maintain the optimum operating temperature, electric vehicles in particular have battery temperature control systems. Normally, this involves cooling systems. However, battery systems are also preheated in order to reduce the internal resistance before a charging process.

Temperature control plates of low overall height have shown to be suitable for realizing a battery temperature control. The temperature control plates are hereby inserted into a battery box and contact the batteries from below.

It would be desirable and advantageous to provide an improved temperature control plate to obviate prior art shortcomings and to enable a control of the temperature of batteries that are arranged on opposite sides of a temperature control plate.

### SUMMARY OF THE INVENTION

According to one aspect of the invention, a temperature control plate, includes a smooth upper cover plate, a smooth lower cover plate, and a support plate arranged between and connected to the upper cover plate and the lower cover plate, the support plate including a temperature control channel profiling to form upper and lower temperature control channels between the support plate and the upper and lower cover plates, with the upper temperature control channels running between the upper cover plate and the support plate and with the lower temperature control channels running between the lower cover plate and the support plate, wherein the support plate includes through openings designed to connect the upper and lower temperature control channels with one another such as to realize a deflection of a temperature control medium, with the through openings designed to exhibit different diameters depending on a length of a path of the temperature control medium from a temperature control medium port to the through openings, with the diameter increasing as the path becomes longer.

The invention resolves prior art shortcomings by providing a temperature control plate with a support plate between a smooth upper cover plate and a smooth lower cover plate. The support plate is connected to the two cover plates. The upper cover plate is intended for contact with an adjacent upper cell plane formed of a plurality of battery cells, and the lower smooth cover plate is intended for contact with an adjacent lower cell plane formed of a plurality of battery cells. A thinnest possible heat conducting foil or a heat conducting medium can be arranged on the smooth upper and lower sides of the cover plates. The aim is to create a contact that is as flat and thermally conductive as possible with the adjacent batteries, which are to be either cooled or heated by the temperature control plate. The cover plates are smooth to realize that 100% of the contact surface with the cell planes are designed as temperature control contacts. In other words, the contact surfaces are free of beads, indentations or openings.

The support plate is provided with a temperature control channel profiling to form temperature control channels between the support plate and the adjacent cover plates. The support plate is preferably at least 50% thicker than the cover plates. The support plate represents the predominantly load-bearing component of the temperature control plate.

The temperature control channel profiling creates on the topside and underside of the support plate indentations which are covered from above and below by the cover plates to thereby form temperature control channels. The cover plates are connected to the support plate via a material bond, e.g. soldered or welded. The outer cover plates are as thin-walled as possible, while the support plate is advantageously thicker-walled and therefore more stress resistant. In this case, the support plate forms the load-bearing structure of the temperature control plate. The support plate is also particularly rigid due to its profiling. As the support plate is also connected to the cover plates over a large area, a hollow profile body with a large number of chambers and connection points is created. The sandwich construction of the temperature control plate with the highly stress-resistant support plate enables a very flat design and a high load-bearing capacity from both sides.

The temperature control plate includes upper temperature control channels, which are arranged between the upper cover plate and the support plate, and lower temperature control channels between the lower cover plate and the support plate. The temperature control channels are advantageously trapezoidal in cross-section. The temperature control channel profiling advantageously involves a series of trapezoidal or channel-shaped embossings running parallel to each other in opposite directions of the support plate. In other words, the support plate is flared in opposite directions by the temperature control channel profiling, so that the temperature control channel profiling protrudes both over the underside of the support plate and in particular also to the same extent over the topside of the support plate, when compared to the initial state of the non-deformed, smooth support plate. Neighboring temperature control channels can differ from each other in cross-section. For thermodynamic reasons, it is advantageous, when the cross-section of the temperature control channels via which the temperature control medium flows in is smaller than the cross-section of the temperature control channels via which the temperature control medium flows out. The temperature control channel profiling can be produced cost-effectively by deep drawing. The trapezoidal shape provides reinforcement and ensures a particularly high stress resistance and permissible surface pressure on the temperature control plate, when compared to a wavy shape.

The upper and lower temperature control channels are connected to each other in a fluid-conducting manner via flow-through openings. The through openings are used to deflect the temperature control medium. Advantageously, the temperature control medium first flows into the lower temperature control channels until reaching the through openings, then flows upwards through the through openings in the direction of the upper temperature control channels and then flows back in the opposite direction to the flow in the lower temperature control channels.

There is at least one through opening in each lower temperature control channel. The provision of several such through openings is also possible. The through openings can be of different sizes to ensure uniform temperature control. For deflection, the through openings are located as far away as possible from the temperature control medium ports, via which the temperature control medium is fed to the support plate and via which the temperature control medium is discharged again.

Advantageously, there is only a single and, in particular, centrally arranged temperature control medium port for the supply flow and return flow, so that the temperature control medium travels different distances to the through opening in the case of several parallel temperature control channels. Through openings with different diameters are provided in order to adjust different flow velocities of the temperature control medium. When requiring a more intensive cooling/heating, the flow velocity should be high. In this case, the through openings are larger. Even if the distances to be covered by the temperature control medium are longer than other distances, so that a greater amount of heat is transferred over the distance, the through opening can be larger. Conversely, the through opening is smaller when the paths are shorter. The temperature differences within the temperature control plate are smaller due to differently sized through openings and the cooling or heating of the battery cells becomes more uniform. The through openings can also be larger in some regions depending on the potential thermal hot spot occurrence of the cell levels.

According to another advantageous feature of the invention, each of the upper and lower cover plates can include a smooth region in adjacent relationship to the upper and lower temperature control channels, respectively, and a border-side collar on the smooth region for connection to the support plate. The collar can be angled in relation to the smooth regions and can also have an outwardly pointing flange via which the collar can be connected to the cover plate. The collars and the smooth regions of the two cover plates advantageously have identical shape. From a manufacturing point of view, the aim is to use identical forming tools for the two cover plates. The collar is advantageously produced by deep drawing. Only after forming, i.e. after deep drawing, is the edge trimmed, e.g. by punching. Simultaneously with punching or edge trimming, openings for temperature control medium ports can also be made in at least one of the cover plates. The cover plates are therefore predominantly identical parts that can be produced cost-effectively.

According to another advantageous feature of the invention, reinforcement strips can respectively be arranged on opposing first and second edge sides of the temperature control plate. The reinforcement strips are used to reinforce the temperature control plate, to handle the entire package and to attach to or in a battery housing the temperature control plate with the cell levels arranged on it. The battery housing has suitable connection points for the reinforcement strips. The reinforcement strips advantageously protrude in relation to the cell levels. The temperature control plate is therefore in particular wider than the cell levels arranged on it. This allows the reinforcement strips to protrude laterally in relation to the cell levels.

The reinforcement strip can be used not only for external securement of the temperature control plate to a battery housing, but may also reinforce the border region of the temperature control plate. According to another advantageous feature of the invention, the reinforcement strip can each be designed as a clamp to span over the upper and lower cover plates. In particular, the reinforcement strip can span a border-side temperature control channel. This has the advantage that the high flexural rigidity of the sandwich construction of the temperature control plate can be continued into the reinforcement strip, so that forces acting on the reinforcement strip can be transmitted safely and with low flexural stress via the sandwich structure.

As an alternative to a reinforcement strip, the support plate can include a fastening edge projecting from the cover plates on diametrical and first and second edge sides of the temperature control plate. The first and second edge sides projecting from the cover plates can be arranged diametrically. Advantageously, the edge sides can be flat so that the support plate can serve as a flat support. The edge sides may also serve to handle the cell levels. The laterally protruding fastening edge can be profiled in order to increase the flexural rigidity of the fastening edge. The fastening edge may moreover have latching lugs to fix the temperature control plate with the batteries attached to it. The fastening edge can also have openings, perforations or notches that can be used to fasten the temperature control plate together with the batteries arranged in it.

A temperature control plate according to the invention is characterized in particular by the fact that it has two opposite smooth sides. The outer cover plates are not profiled in the region intended for temperature control. The cover plates can have a profiling outside the region intended for temperature control, in the sense of a circumferential edge that faces the support plate and serves to virtually place the cover plate over the temperature control channel profiling and to create a contact surface to connect the cover plates to the topside or underside of the support plate. Depending on the orientation, the cover plates have the shape of a very flat hood or very flat trough.

Advantageously, the support plate can have a wall thickness which is greater than the wall thickness of each of the cover plates by at least 50%, preferably 75 to 150%. Advantageously, the support plate can be twice as thick as the cover plate. In the presence of a fastening edge, the wall thickness of the support plate can be less because the force is preferably transmitted to the reinforcement strip via the cover plates. The reinforcement strip designed as a clamp with an essentially U-shaped cross-section can have a leg which points towards the temperature control plate and may even engage between the cell planes in the installation position, so that the one leg or even both legs are partially arranged between the cover plate and the cell plane. This has the advantage that the force can be transferred more directly from the cell planes to the reinforcement strip and the structure of the temperature control plate is thus less stressed. As a result, the temperature control plate can be constructed more easily. In particular, the reinforcement strip can be connected to the other components of the temperature control plate with a material bond.

According to another advantageous feature of the invention, the support plate can be rectangular. The fastening edges of the central support plate or the reinforcement strips can be located on the first and second edges. Combinations of fastening edges and reinforcement strips may also be possible within the scope of the invention.

On a further edge side, the third edge side, the support plate can advantageously have at least one projection for at least one temperature control port. When several of the cell levels are to be arranged one above the other or one behind the other, the temperature control ports can be arranged on opposite edge sides. Advantageously, both temperature control medium ports, i.e. for the inlet and outlet, can be arranged on a same edge side.

The temperature control medium ports can also be arranged on the same cover plate, in particular on the upper cover plate. This design is favorable from a manufacturing point of view, as connection lines for the forward flow and return flow can be mounted from one side. The at least one projection can advantageously be inclined at an angle in the range of 5 to 45° relative to the support plate. This creates an inflow ramp. In addition, the openings for the temperature control medium ports point slightly away from the temperature control plate, which simplifies the attachment of supply and return lines. Flow losses of the liquid temperature control medium are reduced.

When the temperature control medium is supplied at the third edge side and returned at the third edge side, the through openings are advantageously located near the opposite fourth edge side. Thus, the temperature control channels can be oriented in such a way that the temperature control medium first flows from the third to the fourth edge side, is deflected there via the through openings and flows back to the third edge side.

The temperature control medium ports may both advantageously be arranged in a central region of the third edge side. A coolant is then able to flow into those channels that lead directly to the central region of the opposite fourth edge side. In order to avoid excessive cooling due to high coolant velocities in the central region, the through openings with the smallest diameter can be arranged in the central region of the fourth edge side and the through openings with the larger diameter can be arranged adjacent to the first and second edge regions. Neighboring through openings can have different diameters, so that different flow velocities always occur in neighboring coolant channels and the heat transfer becomes more uniform when viewed over the entire surface.

According to another advantageous feature of the invention, provision may be made for both temperature control medium ports, i.e. the one for the inlet and the one for the outlet, to be arranged close to each other in order to simplify assembly of the temperature control plate. Advantageously, both temperature control medium ports can be located on the upper cover plate. The support plate can have a through-flow opening that is connected via an inflow channel to the lower temperature control channels. The temperature control medium is intended to flow directly from the temperature control medium port, which serves as the inlet, via the through-flow opening of the support plate so that the temperature control medium is located on the underside of the support plate and is distributed by the inlet channel to all the temperature control channels running parallel to each other, then flows to the through openings, from there into the upper temperature control channels on the topside of the support plate and finally flows back to the temperature control medium port for the outlet in the upper cover plate. The upper cover plate can have an outflow channel that is connected to the upper temperature control channels. To ensure a sufficiently large cross-section in the area of the central temperature control medium supply and the temperature control medium discharge, the support plate can have beads in the region of the inflow channel and in the region of the outflow channel to thereby increase the respective flow cross-section of the inflow channel and/or the outflow channel. Advantageously, the beads face in opposite directions. One of the beads also can have the through-flow opening for the inlet of the temperature control medium. The support plate forms the load-bearing center layer for the temperature control medium ports in the form of a projection. The projection can be bent at an acute angle of 5 to 45° relative to a center plane of the temperature control plate in the temperature control region between the cell planes, thereby forming an inflow ramp. The temperature control medium does not have to be deflected as much. The pressure losses are lower. In this case, the upper and lower cover plates can also be angled.

According to another advantageous feature of the invention, the temperature control channels can be trapezoidal in cross-section, with each of the temperature control channels having walls which extend between the upper cover plate and the lower cover plate and are formed by the support plate, wherein the walls of the temperature control channels form an internal angle with a corresponding one of the upper and lower cover plates which covers a corresponding one of the temperature control channels. As steeper walls, i.e. increasing internal angle, render creation of the through openings more difficult, the through openings are advantageously arranged in a wall region in which the internal angle is locally reduced. This wall region is therefore locally flattened and, in particular, embossed, so that a through-flow opening can be produced, advantageously by punching. The flattened wall area, which should only have a slight inclination to the plate plane of the support plate, is only useful where the perforation is to be made.

A temperature control plate according to the invention can be manufactured inexpensively, especially when the temperature control channel profiling is produced by deep-drawing the base material for the support plate. Profiling can be designed according to temperature requirements, i.e. larger and smaller temperature control channels are possible, depending on which flow velocities are desired in the respective regions of the temperature control plate. The support plate of the temperature control plate has a particular support function with regard to the upper and lower cell levels, which can be connected to the temperature control plate. The inflow ramp reduces flow losses.

According to another aspect of the invention, a battery storage arrangement for mobile or stationary applications includes an upper cell level formed from a plurality of battery cells, a lower cell level formed from a plurality of battery cells, and a temperature control plate as described above, which is arranged between the upper and lower cell levels for temperature control.

According to another advantageous feature of the invention, the battery storage arrangement can include a battery housing, wherein the afore-described temperature control plate can have opposing first and second edge sides, reinforcement strips respectively arranged on the first and second edge sides, and/or wherein the afore-described support plate can have a fastening edge. The temperature control plate can then be fastened to or in the battery housing via the reinforcement strips and/or via the fastening edges.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a perspective view of a first embodiment of a temperature control plate with cell levels arranged thereon;

FIG. 2 shows a perspective view of the temperature control plate of FIG. 1 without cell levels;

FIG. 3 shows a cross-section through the temperature control plate with the cell levels, taken along section line III-III of FIG. 1;

FIG. 4 shows an exploded view of the temperature control plate of FIG. 2;

FIG. 5 shows an illustration of a flow path of an inflowing temperature control medium within the temperature control plate;

FIG. 6 shows an illustration of a flow path of an outflowing temperature control medium within the temperature control plate;

FIG. 7 shows a perspective view of through openings in the support plate;

FIG. 8 shows a detail of an upper cover plate of the temperature control plate in an area of a temperature control medium port;

FIG. 9 shows a detail of the support plate in an area of the temperature control medium port;

FIG. 10 shows a detail of a lower cover plate of the temperature control plate in the area of the temperature control medium port;

FIG. 11 shows a perspective view of a second embodiment of a temperature control plate with cell levels arranged thereon;

FIG. 12 shows a cross-section of the temperature control plate of FIG. 11, taken along section line XII-XII;

FIG. 13 shows an enlarged detailed view of the area encircled in FIG. 12;

FIG. 14 shows an exploded view of the temperature control plate of FIG. 11; and

FIG. 15 shows a perspective view upon through openings in the support plate.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments may be illustrated by graphic symbols, phantom lines, diagrammatic representations and fragmentary views. In certain instances, details which are not necessary for an understanding of the present invention or which render other details difficult to perceive may have been omitted.

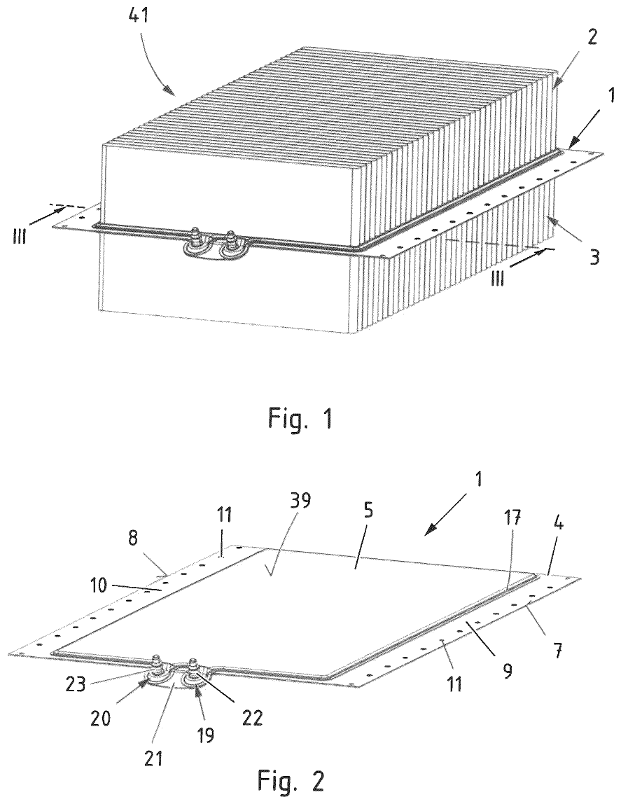

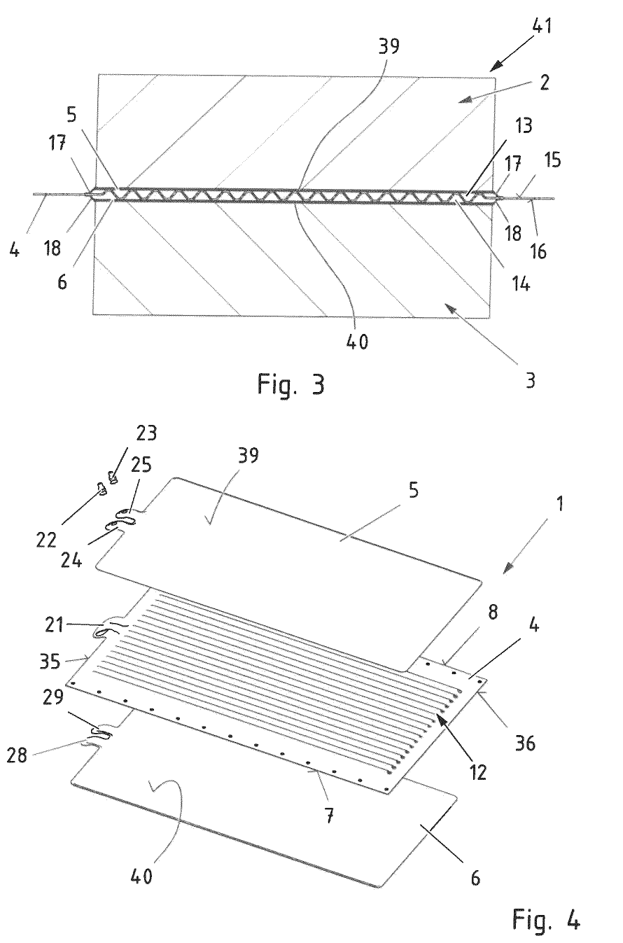

Turning now to the drawing, and in particular to FIG. 1, there is shown a perspective view of a first embodiment of a temperature control plate, generally designated by reference numeral 1 and arranged between an upper cell level 2 and a lower cell level 3. The two cell levels 2, 3 together with the temperature control plate 1 form a battery storage arrangement, generally designated by reference numeral 41. Each cell level 2, 3 is formed from a plurality of battery cells. FIG. 2 shows the temperature control plate 1 without the two cell levels 2, 3. A section along line III-III of FIG. 1 is shown in FIG. 3. FIG. 4 shows an exploded view.

The rectangular temperature control plate 1 has a 3-layer structure comprised of a central support plate 4, which is covered by a smooth upper cover plate 5 and a smooth lower cover plate 6. Smooth regions 39, 40 are intended for temperature control contact with the cell levels 2, 3. The two cover plates 5, 6 are also rectangular, but slightly smaller than the support plate 4. The temperature control plate 1 has diametrically arranged first and second edge sides 7, 8, with the support plate 4 having fastening edges 9, 10 projecting laterally from the narrower cover plates 5, 6. The two fastening edges 9, 10 have several openings 11, via which the temperature control plate 1 can be secured together with the cell levels 2, 3. It is possible to secure the temperature control plate 1 with the cell levels 2, 3 to or in a battery housing using the fastening edges 9, 10. The support plate 4 assumes a supporting function for the entire arrangement comprised of the two cell levels 2, 3 and the central temperature control plate 1.

A special feature of the invention is that both the upper cover plate 5 and the lower cover plate 6 are smooth. The smooth upper and lower sides of the temperature control plate 1 are covered with a heat exchanger, for example a thin heat conducting film, in order to create a connection to a battery support surface. In the case of the upper cell level 2, this is the underside of the cell level 2 and in the case of the lower cell level 3 in the image plane of FIG. 3, this is the topside of the cell level 3. The cover plates 5, 6 have the function of at least thermally connecting the cell levels 2, 3 to the temperature control plate 1, with the central support plate 4 predominantly assuming the support function of the entire temperature control plate 1.

Another special feature of the invention is that the support plate 4 includes a temperature control channel profiling 12. The sectional view in FIG. 3 clearly shows that the temperature control channel profiling 12 is trapezoidal in cross-section. All the individual temperature control channels 13, 14 thus formed have a same cross-section. The upper and lower temperature control channels 13, 14 are created by the fact that the temperature control channel profiling 12 of the central support plate 4 is covered by the upper and lower cover plates 5, 6. As a result, the individual temperature control channels 13, 14 each have a trapezoidal cross-section. FIG. 3 shows that the temperature control channel profiling 12 projects on both sides of the support plate 4. The temperature control channel profiling 12 projects beyond a topside 15 and an underside 16 of the support plate 4 by a multiple of the thickness of the support plate 4. In the exemplified embodiment shown here, the wall thickness of the cover plates 5, 6 is only half the wall thickness of the support plate 4.

The sectional view in FIG. 3 shows that collars 17, 18 of the otherwise smooth cover plates 5, 6 protrude outwards from the cell planes 2, 3 and are bent twice. The two cover plates 5, 6 are connected via the collars 17, 18 to the central support plate 4 via a material bond, e.g. soldered or welded.

The trapezoidal profile of the support plate 4 has a web between neighboring upper and lower temperature control channels 13, 14, with the web running parallel to the smooth upper cover plate 5 and parallel to the smooth lower cover plate 6. The support plate 4 is connected to the two cover plates 5, 6 via the webs. The sandwich construction of this hollow profile body has a high load-bearing capacity. For example, the support plate 4 can support cell levels 2, 3, which can weigh 100 kg or more per side. At the same time, the temperature control plate 1 is very space-saving and cost-effective to manufacture.

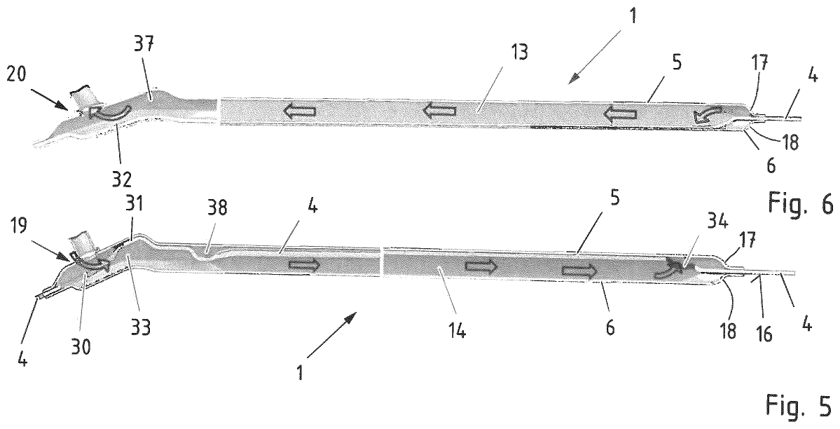

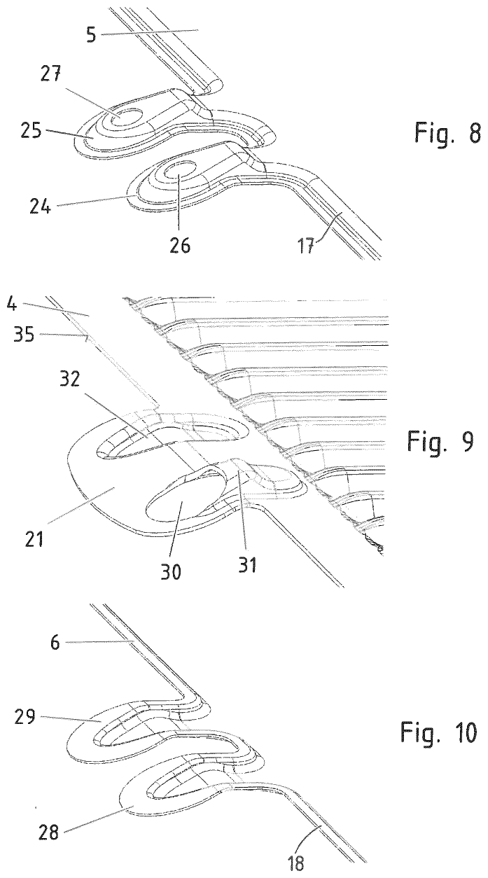

FIGS. 5 and 6 show the flow path within the temperature control plate 1. A temperature control medium is first introduced into the lower temperature control channels 14 (FIG. 5). These are the channels located on the underside 16 of the central support plate 4. Temperature control medium ports 19, 20 for the supply and return are located on the upper cover plate 5 (FIG. 2). The temperature control medium port 19 can also be referred to as an inlet ramp, because a projection 21 which is arranged on the edge and on which the temperature control medium ports 19, 20 are arranged, is bent like a ramp relative to the center plane of the support plate 4. As a result, connection pieces 22, 23, which are secured to the upper cover plate 5, do not protrude vertically upwards but at an angle upwards, and point away from the cell levels 2, 3. For this purpose, the upper cover plate 5 has connection openings 26, 27 (FIG. 8), to which the connection pieces 22, 23 are attached. The upper cover plate 5 has two finger-like projections 24, 25 for this purpose, as can be seen in detail in FIG. 8. The connection openings 26, 27 are formed in these two projections 24, 25 for the connection pieces 22, 23. FIG. 9 shows that the central projection 21 of the support plate 4 is not split into two parts, but is the load-bearing connection element between the finger-like projections 24, 25 of the upper cover plate 5. FIG. 10 shows that the lower cover plate 6 also has two finger-like projections 28, 29. In the assembled position, the one-piece projection 21 serves as a connecting link for all projections 24, 25, 28, 29 of the upper and lower cover plates 5, 6.

In order for the inflowing temperature control medium to pass from the upper connection opening 26 to the underside of the support plate 4, the projection 21 of the support plate 4 has a connection opening 30, which is connected to the connection opening 26. In addition, beads 31, 32 oriented in opposite directions are located in the projection 21 of the support plate 4 so as to increase the flow cross-section for the inflowing and outflowing temperature control medium. Provision is also made for beads in the finger-like projections 24, 25 of the upper cover plate 5 and in the finger-like projections 28, 29 of the lower cover plate 6 in order to provide the necessary cross-section for the fluid flow. In the assembled state, the three plate components form an inflow channel 33 and an outflow channel 37, as shown in the different sectional views of FIGS. 5 and 6. FIG. 5 shows in the sectional plane through the temperature control medium port 19, which serves as the inlet, that the temperature control medium flows through the connection opening 30 of the support plate 4 and is directed into the lower temperature control channel 14. The temperature control channel 14 extends to a through opening 34. The temperature control medium inlet 19 is located at a third edge 35 of the temperature control plate 1. A through opening 34 in the temperature control channel 14 is arranged adjacent to the opposite fourth edge 36. The through opening 34 directs the temperature control medium into the upper temperature control channels 13. The further flow path can be seen in FIG. 6. There, it flows from the fourth edge 36 back towards the third edge 35 and via an outflow channel 37 between the finger-like projection 25 above the bead 32 to the temperature control medium port 20, which serves as an outlet. The sectional view in FIG. 5 shows the arrangement of a collecting chamber 38 which extends transversely to the upper and lower temperature control channels 13, 14 and into which all upper temperature control channels 14 feed, with the collecting chamber 38 near the third edge 35 ultimately feeding the temperature control medium to the outlet channel 37.

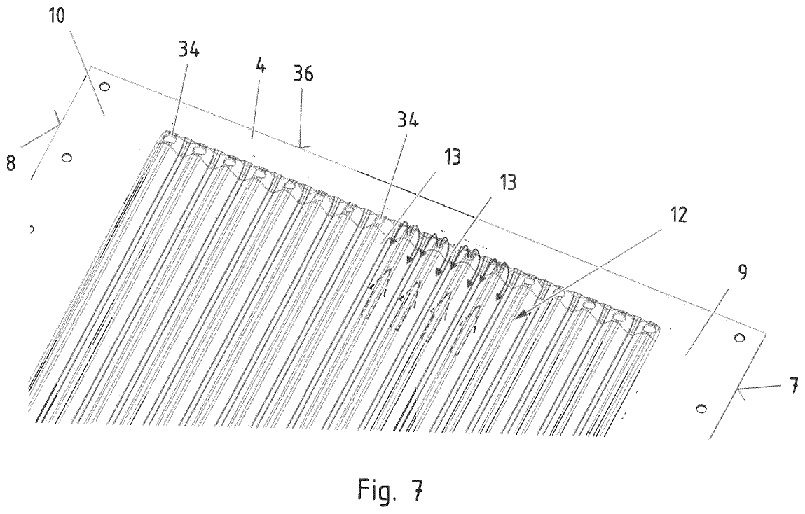

The temperature control medium therefore has different distances to flow within the temperature control plate 1 until it reaches the outlet again. For this reason, the through openings 34 are configured in different sizes. FIG. 7 shows the flow of the temperature control medium above and below the central support plate 4. The dashed arrows illustrate that the temperature control fluid flows along the underside. All trapezoidal temperature control channels on the underside of the support plate 4 are flowed through in parallel in a same direction, i.e. from the third edge 35 towards the fourth edge 36 and parallel to the other two edges 7, 8. The temperature control medium exits the lower temperature control channels 14 through the individual through openings 34 and flows into the adjacent temperature control channels 13 arranged on the topside of the support plate 4. The temperature control medium flow is split between two neighboring temperature control channels 13 on the topside. This is shown by the two arrows which are drawn with a solid line and lead out of each of the through openings 34.

FIG. 7 also shows that the through openings have different diameters. For the sake of simplicity, all through openings 34 are designated with the same reference sign. Still, a through opening 34 adjacent to the first or second edge 7, 8 has a significantly larger diameter than a through opening 34 in the central region. The through openings 34 located in between have graduated diameters and become smaller and smaller towards the center. In this way, a homogenization of the heat dissipation can be achieved. The flow velocities in adjacent temperature control channels 13, 14 are always different. Neighboring through openings 34 have different diameters.

The longer the path of the temperature control medium through the temperature control plate 1, the larger the through opening 34. The shorter or the more direct the flow, the smaller the cross-section of the through opening 34.

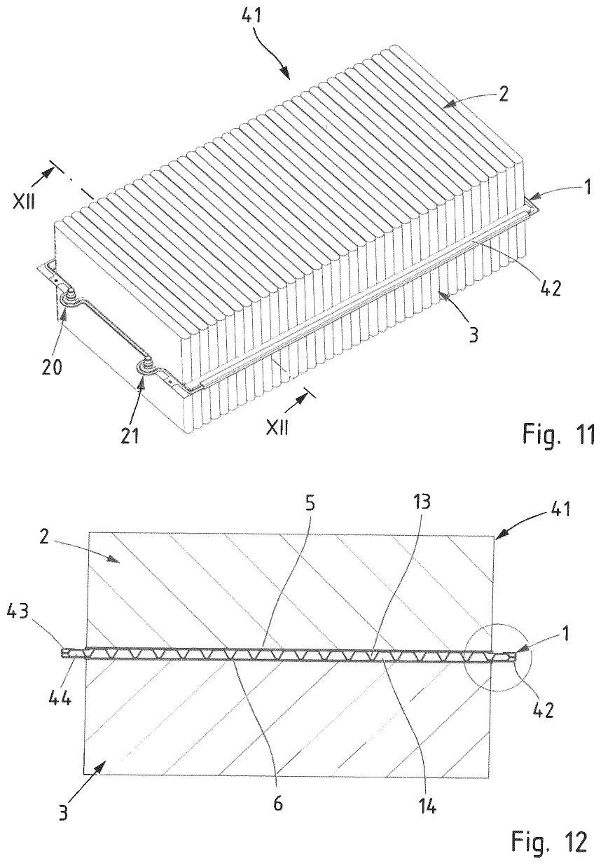

FIGS. 11 to 14 show a second embodiment of a temperature control plate 1 that differs from the first exemplified embodiment in terms of design of the temperature control plate. To avoid repetition, reference is made to the previous description with regard to the explanation of the function. The following description mainly focuses on the differences. Same reference numbers introduced for FIGS. 1 to 10 are used for components that are essentially identical in function in the following description.

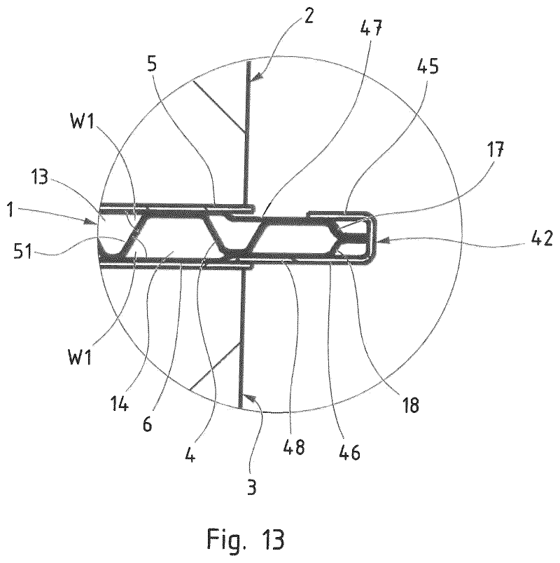

FIG. 11 shows a battery storage arrangement 41 with the two cell levels 2, 3 and a temperature control plate 1, which has reinforcement strips 42, 43 instead of fastening edges. The reinforcement strips 42, 43 are components in the form of brackets with a U-shaped cross-section. The reinforcement strips 42, 43 embrace the upper and lower cover plates 5, 6 on the top and bottom. The cover plate 4 does not protrude laterally beyond the collars 17, 18 of the cover plates 5, 6 in the area of the reinforcement strips 42, 43. Instead, the cover plates 5, 6 protrude overall slightly in relation to the cell levels 2, 3, so that the reinforcement strips 42, 43 not only overlap the collars 17, 18, but also a border-side temperature control channel 44. The reinforcement strips 42, 43 have a back and two upper and lower legs 45, 46 which are connected to the back and which run parallel to each other and point in the direction of the temperature control plate 1. The lower leg 45 is sized longer than the upper leg 46. The lower leg 45 engages between the lower cell level 3 and the lower cover plate 6. The shorter upper leg 46 does not engage under the upper cell level 2 and ends at a distance from the cell level 2. The two legs 45, 46 rest on steps 47, 48 running along the edge sides of the upper and lower cover plates 4, 5. In the area of the strip-shaped steps 47, 48, the thickness of the temperature control plate 1 is reduced so that the legs 45, 46 do not protrude beyond the smooth region 39, 40 in the thickness direction (FIG. 13). The reinforcement strips 42, 43 are therefore not thicker than the temperature control plate 1. The reinforcement strips 42, 43 represent a non-detachable component of the temperature control plate 1.

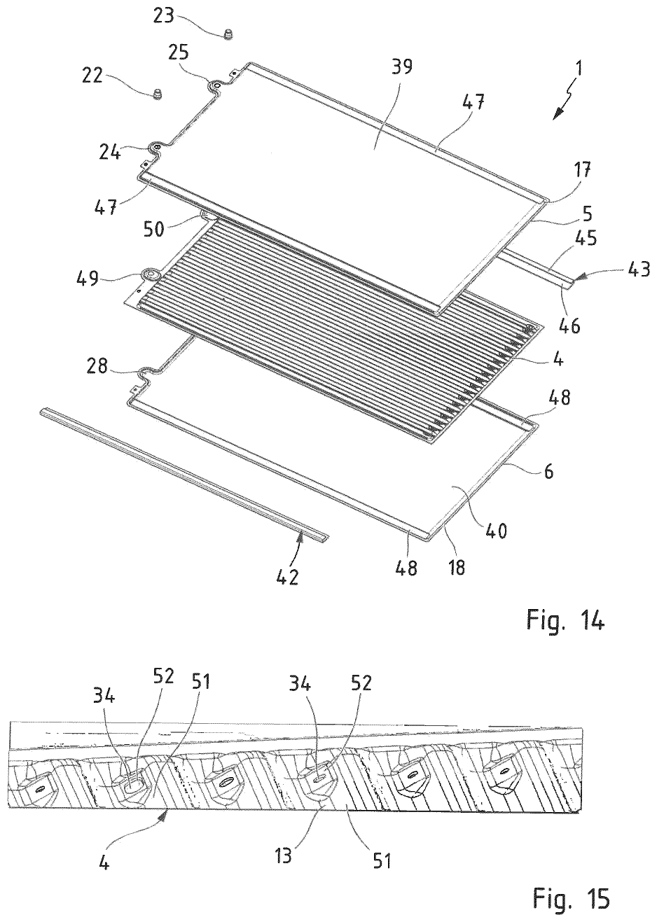

In this embodiment, the temperature control ports 19, 20 are arranged at a greater distance from each other. The support plate 4 therefore has two separate projections 49, 50 (FIG. 14). FIG. 12 also shows that the cross-sections of the upper and lower temperature control channels 13, 14 are different in size. In this case, the cross-section of the lower temperature control channels 14 is larger. The temperature control channels 13, 14 are trapezoidal. The walls 51 form an internal angle W1 with the adjacent cover plates 5, 6 (FIG. 13). The walls 51 are less steep locally in the area of the flow openings 34, i.e. flattened, in order to make it easier to produce the flow openings 34 after shaping the support plate 4. FIG. 15 shows that the through openings 34 are arranged in a wall region 52 of the walls 51, which wall region 52 has a reduced internal angle, i.e. the wall region 52 is flatter and is not as steep in relation to the plane of the support plate 4 as the walls 51.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A temperature control plate, comprising:
a smooth upper cover plate;
a smooth cover plate; and
a support plate arranged between and connected to the upper cover plate and the lower cover plate, said support plate including a temperature control channel profiling to form upper and lower temperature control channels between the support plate and the upper and lower cover plates, with the upper temperature control channels running between the upper cover plate and the support plate and with the lower temperature control channels running between the lower cover plate and the support plate, said support plate including through openings designed to connect the upper and lower temperature control channels with one another such as to realize a deflection of a temperature control medium, said through openings designed to exhibit different diameters depending on a length of a path of the temperature control medium from a temperature control medium port to the through openings, with the diameter increasing as the path becomes longer.

2. The temperature control plate of claim 1, wherein each of the upper and lower cover plates includes a smooth region in adjacent relationship to the upper and lower temperature control channels, respectively, and a border-side collar on the smooth region for connection to the support plate, wherein the collar and the smooth region of the upper cover plate and the collar and the smooth region of the lower cover plate have identical shape.

3. The temperature control plate of claim 1, further comprising reinforcement strips respectively arranged on opposing first and second edge sides of the temperature control plate.

4. The temperature control plate of claim 3, wherein the reinforcement strips are each designed as a clamp to span over the upper and lower cover plates.

5. The temperature control plate of claim 3, wherein the reinforcement strips include each an opening for fastening the temperature control plate to a housing, in particular to a battery housing.

6. The temperature control plate of claim 1, wherein the support plate includes fastening edges on opposing first and second edge sides of the temperature control plate and projecting in relation to the upper and lower cover plates.

7. The temperature control plate of claim 6, wherein the fastening edges have each openings for fastening the temperature control plate, in particular to a battery housing.

8. The temperature control plate of claim 1, wherein the support plate is rectangular and includes a projection on a third edge side for the temperature control medium port on one of the upper and lower cover plates.

9. The temperature control plate of claim 8, wherein the projection is inclined at an angle in a range of 5 to 45° in relation to the support plate.

10. The temperature control plate of claim 8, wherein the through openings for deflecting the temperature control medium are arranged adjacent to a fourth edge side, which is opposite the third edge side.

11. The temperature control plate of claim 1, wherein the temperature control channels are trapezoidal in cross-section, with each of the temperature control channels having walls which extend between the upper cover plate and the lower cover plate and are formed by the support plate, wherein the walls of the temperature control channels enclose an internal angle with a corresponding one of the upper and lower cover plates which covers a corresponding one of the temperature control channels, wherein the through openings are arranged in a wall region in which the internal angle is reduced.

12. The temperature control plate of claim 8, wherein the temperature control medium port is provided for inflow of the temperature control medium and is arranged on the upper cover plate, said support plate including a connection opening which is connected to an inflow channel to the lower temperature control channels, and wherein a further temperature control medium port is provided for outflow of the temperature control medium and connected to the upper cover plate, said further temperature control medium port communicating with an outflow channel which is connected to the upper temperature control channels.

13. The temperature control plate of claim 12, wherein the support plate includes beads designed to increase a flow cross-section in a region of the inflow channel and the outflow channel.

14. A battery storage arrangement, comprising:
an upper cell level formed from a plurality of battery cells;
a lower cell level formed from a plurality of battery cells; and
the temperature control plate of claim 1 arranged between the upper and lower cell levels.

15. The battery storage arrangement of claim 14, further comprising a battery housing, said temperature control plate including opposing first and second edge sides, and reinforcement strips respectively arranged on the first and second edge sides.

16. The battery storage arrangement of claim 15, wherein the temperature control plate is fastened to the battery housing by the reinforcement strips.

17. The battery storage arrangement of claim 14, wherein the support plate includes fastening edges for fastening the temperature control plate to the battery housing.
